(19) United States
(12) Patent Application Publication
(10) Pub. No.: US 2010/0238363 A1
(43) Pub. Date: Sep. 23, 2010

(54) Image Display Apparatus, Image Display Method, and Image Display Program Embodied on Computer Readable Medium

(75) Inventor: Tomoyuki OKAMOTO, Suita-shi (JP)

Correspondence Address: MORRISON & FOERSTER LLP, 1650 TYSONS BOULEVARD, SUITE 400, MCLEAN, VA, 22102, US

(73) Assignee: Konica Minolta Business Technologies, Inc., Tokyo (JP)

(21) Appl. No.: 12/725,198

(22) Filed: Mar. 16, 2010

(30) Foreign Application Priority Data
Mar. 17, 2009 (JP) 2009-064873

(51) Int. Cl. H04N 9/31

(52) U.S. Cl. 348/744; 348/E09.025

(57) ABSTRACT

In order to display an image that reflects the intents of viewers who see a displayed image, a projector includes a display control portion to output an image for display, a message reception portion to receive a message from one or more computers connected to be able to communicate, a count portion to count one or more received messages, and a change portion to change the image for display based on the number of counted messages, if one or more messages are received.

This application is based on Japanese Patent Application No. 2009-064873 filed with Japan Patent Office on Mar. 17, 2009, the entire content of which is hereby incorporated by reference.

### BACKGROUND OF THE INVENTION

1. Field of the Invention

The present invention relates to an image display apparatus, an image display method, and an image display program embodied on a computer readable medium, and more particularly to an image display apparatus, an image display method, and an image display program embodied on a computer readable medium for displaying images of materials presented in meetings and the like.

2. Description of the Related Art

Images of materials for illustrations are projected on screens in meetings and the like. In recent years, materials for illustrations are often stored in a computer connected to a projector or the like serving as a display apparatus so that the projector displays images of the materials output by the computer.

Images for illustrations are usually displayed in the order prepared by a presenter, and therefore the intents of participants are often not reflected on the presenter. Meanwhile, Japanese Patent Laid-Open No. 2002-149145 discloses a presentation apparatus including interest level detection means for detecting the degree of interest of participants in a presentation, selection means for selecting at least one of a plurality of predetermined slide progress patterns in accordance with the degree of interest detected by the interest level detection means, and display means for displaying slides in a progress order based on the slide progress pattern selected by the selection means.

In the conventional presentation apparatus, however, the slide progress order is changed in accordance with the intent of participants, and the presenter cannot know the intent of participants. Even if a plurality of slide progress patterns are determined in advance by predicting the intents of participants, it has to be determined which of the predicted intents of participants corresponds to the selected slide progress pattern.

### SUMMARY OF THE INVENTION

The present invention is made to solve the aforementioned problem, and an object of the present invention is to provide an image display apparatus capable of displaying an image that reflects the intent of viewers who see the displayed image.

Another object of the present invention is to provide an image display method capable of displaying an image that reflects the intent of viewers who see the displayed image.

A further object of the present invention is to provide an image display program embodied on a computer readable medium that is capable of displaying an image that reflects the intent of viewers who see the displayed image.

In order to achieve the aforementioned object, in accordance with an aspect of the present invention, an image display apparatus includes: a display control portion to output an image for display; a reception portion to receive a message from one or more computers connected to be able to communicate; a count portion to count one or more messages received by the reception portion; and a change portion to change the image for display based on the number of counted messages, if one or more messages are received by the reception portion.

In accordance with another aspect of the present invention, an image display system includes an image display apparatus and one or more computers. The image display apparatus includes a display control portion to output an image for display, a message reception portion to receive a message from one or more computers connected to be able to communicate, a count portion to count one or more messages received by the reception portion, a change portion to change the image for display based on the number of counted messages, if one or more messages are received by the reception portion, and a transmission portion to transmit the image for display to each of the one or more computers. Each of the one or more computers includes an image reception portion to receive the image for display, an instruction accepting portion to accept an instruction by a user, and a message transmission portion to transmit a message based on the accepted instruction.

In accordance with a further aspect of the present invention, an image display method includes the steps of: outputting an image for display; receiving a message from one or more computers connected to be able to communicate; counting one or more messages received by the reception portion; and changing the image for display based on the number of counted messages, if one or more messages are received by the reception portion.

In accordance with yet another aspect of the present invention, an image display program embodied on a computer readable medium allows a computer to execute the steps of: outputting an image for display; receiving a message from one or more computers connected to be able to communicate; counting one or more messages received by the reception portion; and changing the image for display based on the number of counted messages, if one or more messages are received by the reception portion.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram showing an overview of a meeting system in an embodiment of the present invention.

FIG. 2 is a block diagram showing an exemplary overall configuration of a projector.

FIG. 3 is a block diagram showing an exemplary hardware configuration of PC.

FIG. 4 is a functional block diagram showing an example of functions of CPU included in the projector.

FIG. 5 is a diagram showing an example of a count table.

FIG. 6 is a functional block diagram showing an example of functions of CPU included in PC operated by a participant.

FIG. 7 shows an example of a presentation screen.

FIG. 8 is a flowchart showing an exemplary flow of an image display process.

FIG. 9 is a flowchart showing an exemplary flow of a change process.

FIG. 10 is a flowchart showing an exemplary flow of a message process.

FIG. 11 shows an example of a composite image.

FIG. 12 shows an example of a composite image in a modified embodiment.

### DESCRIPTION OF THE PREFERRED EMBODIMENTS

In the following, embodiments of the present invention will be described with reference to the figures. In the following description, the same parts are denoted with the same reference numerals. Their names and functions are also the same. Therefore, a detailed description thereof will not be repeated.

### First Embodiment

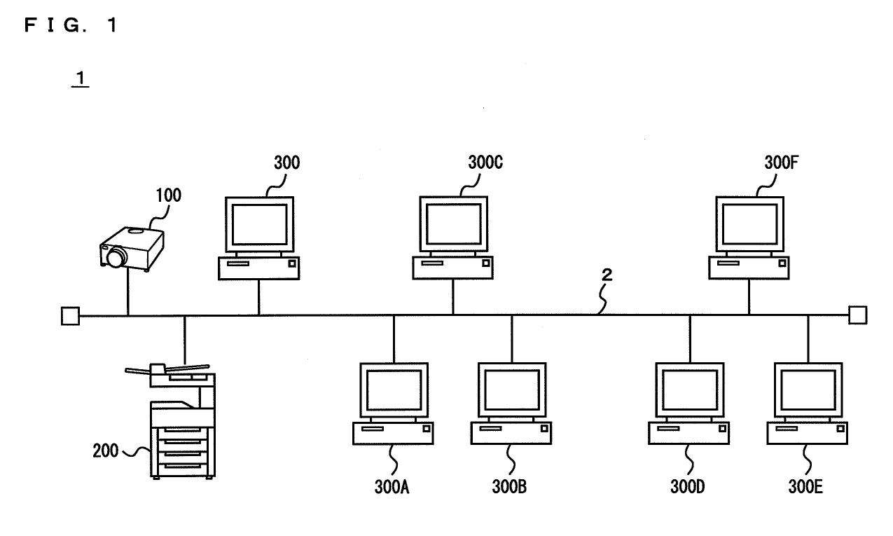

FIG. 1 is a diagram showing an overview of a meeting system in an embodiment of the present invention. Referring to FIG. 1, a meeting system 1 includes a projector 100 serving as an image display apparatus, an MFP (Multi Function Peripheral) 200, and a plurality of personal computers (hereinafter referred to as “PC”) 300, 300A-300F, each of which is connected to a network 2. Here, a presenter operates PC 300 to allow projector 100 to project images of materials for illustration, and participants operate PC 300A-300F to view the materials, by way of example.

Network 2 is a local area network (LAN) and the form of connection can be wired or wireless. In addition, network 2 is not limited to a LAN and can be a wide area network (WAN), a Public Switched Telephone Network (PSTN), the Internet, and so on.

Although a description here will be made to a case where a presentation is given in one meeting room, participants may be present in a plurality of spaces physically separated from each other. In the latter case, another projector is additionally arranged in a space physically separated from the space in which projector 100 is arranged, and the same images as those displayed by projector 100 are also displayed by another projector. This is a well-known technique as a so-called teleconference system.

Projector 100 can communicate with PC 300, 300A-300F via network 2 to display images received from PC 300 operated by the presenter. Although projector 100 is taken here as an example, such a display as a liquid crystal display (LCD) or an organic ELD (Electroluminescence Display) may be employed.

PC 300, 300A-300F are general computers and have application programs installed therein for communicating with projector 100.

MFP 200 includes a scanner for scanning documents, an image forming apparatus for forming images on a recording medium such as paper, and a facsimile machine and has an image scanning function, a copy function, and a facsimile transmission/reception function.

In the present embodiment, a presenter of a meeting stores presentation data, which is electronic data of materials for presentation, in PC 300 and remotely operates projector 100 by PC 300 to allow projector 100 to display presentation data. The format of presentation data is not limited as long as it can be read by projector 100. Here, the presentation data includes a plurality of pages, by way of example. Images of a plurality of pages included in presentation data is transmitted in order from PC 300 to projector 100, so that projector 100 displays the images received from PC 300. Presentation data may be transmitted from PC 300 to projector 100 in advance so that images of a plurality of pages included in the presentation data may be displayed in order in accordance with an instruction to page up/down that is transmitted from PC 300 and received by projector 100.

On the other hand, participants of a meeting operate PC 300A-300F. Projector 100 sends the same image as it displays, to PC 300A-300F, so that each of PC 300A-300F displays the image received from projector 100. Therefore, the participants can view the same image as the image projected by projector 100 on a display portion 306 of PC 300A-300F.

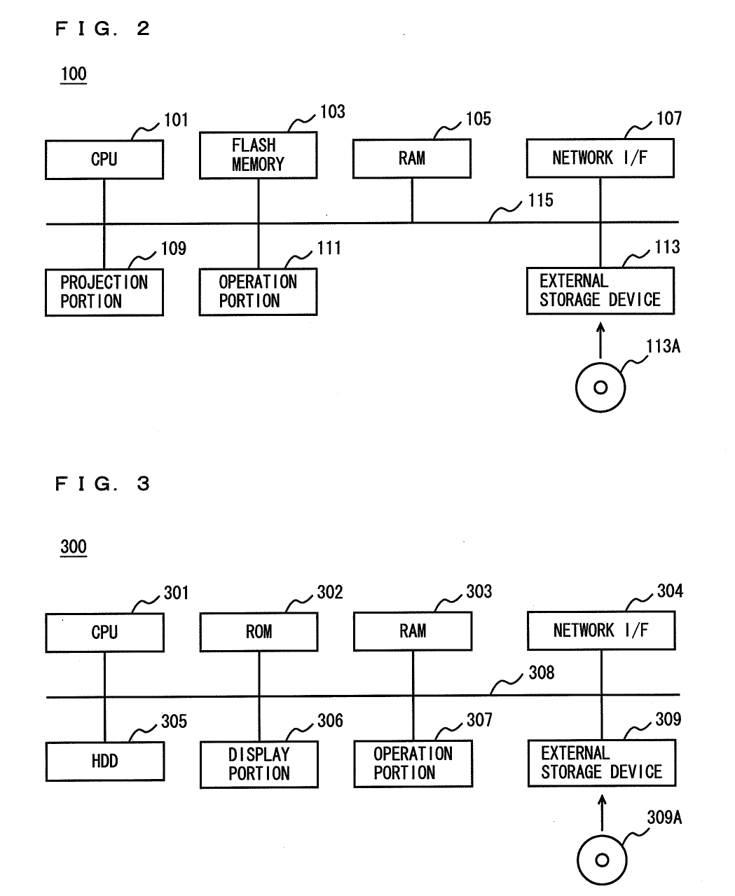

FIG. 2 is a block diagram showing an exemplary overall configuration of the projector. Referring to FIG. 2, projector 100 includes a central processing unit (CPU) 101 for controlling the entire projector 100, a flash memory 103 for storing programs and the like executed by CPU 101, a RAM (Random Access Memory) 105 for use as a work area for CPU 101, a network interface I/F 107 for connecting projector 100 to network 2, a projection portion 109 for projecting images, an operation portion 111 accepting input of the user's operations, and an external storage device 113, each of which is connected to a bus 115.

Projection portion 109 includes a liquid crystal display, a lens, and a light source to display images. The liquid crystal display displays images. Light emitted from the light source passes through the liquid crystal display and radiates out through the lens. The light emitted from projection portion 109 is applied on a screen so that an image that is enlarged from the image displayed on the liquid crystal display is projected on the screen. Any plane having a high reflectivity such as a wall can be used, and in such a case, a screen does not have to be installed.

Flash memory 103 stores programs executed by CPU 101 or data necessary to execute those programs. RAM 105 is used as a work area when CPU 101 executes a program.

Network I/F 107 is an interface for connecting projector 100 to network 2. CPU 101 communicates with PC 300, 300A-300F and MFP 200 through network I/F 107 to transmit/receive data. Network I/F 107 can also communicate with a computer connected to the Internet via network 2.

CD-ROM (Compact Disc-Read Only Memory) 113A is attached to external storage device 113. CPU 101 can access CD-ROM 113A through external storage device 113. CPU 101 loads an image display program stored in CD-ROM 113A attached to external storage device 113 into RAM 105 for execution. It is noted that the program executed by CPU 101 is not limited to a program stored in CD-ROM 113A and may be a program stored in flash memory 103. In this case, another computer connected to network 2 may overwrite a program stored in flash memory 103 of projector 100 or additionally write a new program. Furthermore, projector 100 may download a program from another computer connected to network 2 and store the program in flash memory 103. The program referred to herein includes not only a program directly executable by CPU 101 but also a source program, a compressed program, an encrypted program, and the like.

Here, a recording medium having the image display program stored therein is not limited to CD-ROM 113A and may be a flexible disk, a cassette tape, an optical disk (MO (Magnetic Optical Disc)/MD (Mini Disc)/DVD (Digital Versatile Disc)), an IC card, an optical card, or a semiconductor memory such as a mask ROM, EPROM, or EEPROM.

PC 300, 300A-300F have the same configuration and function, and therefore PC 300 will be illustrated as an example. FIG. 3 is a block diagram showing an exemplary hardware configuration of PC. Referring to FIG. 3, PC 300 includes a CPU 301 for controlling the entire PC 300, a ROM 302 for storing programs and the like executed by CPU 301, a RAM 303 for use as a work area for CPU 301, a network I/F 304 for connecting PC 300 to a network, an HDD 305 as a mass storage device, a display portion 306, an operation portion 307 accepting input of the user's operation, and an external storage device 309, each of which is connected to a bus 308.

CD-ROM 309A storing a program is attached to external storage device 309. CPU 301 loads the image display program stored in CD-ROM 309A through external storage device 309 into RAM 303 for execution. The image display program stored in HDD 305 may be loaded in RAM 303 for execution. In this case, PC300 may download a program from another computer connected to network 2 and store the program in HDD 305. The program referred to herein includes not only a program directly executable by CPU 301 but also a source program, a compressed program, an encrypted program, and the like.

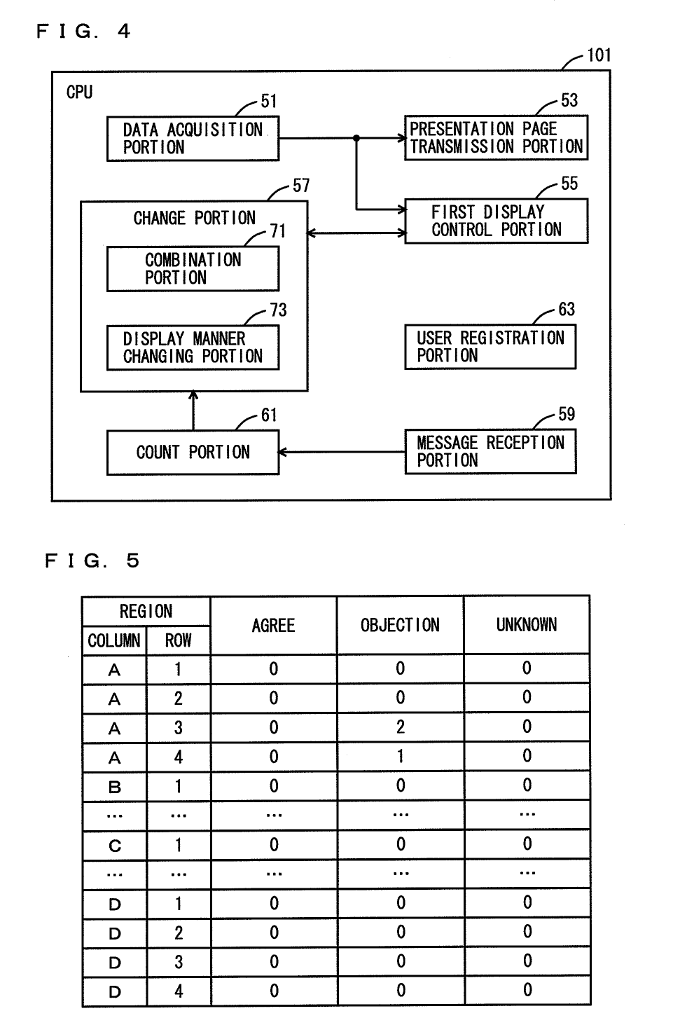

FIG. 4 is a functional block diagram showing an example of functions of CPU included in the projector. Such functions are realized by CPU 101 executing the program stored in flash memory 103 or CD-ROM 113A. Referring to FIG. 4, CPU 101 of projector 100 includes, as the functions realized by execution of the above-noted program, a data acquisition portion 51 for acquiring data, a presentation page transmission portion 53 for transmitting the acquired data, a first display control portion 55 for controlling projection portion 109, a change portion 57 for changing an image of data, a message reception portion 59 for receiving a message, a message count portion 61 for counting messages, and a user registration portion 63.

User registration portion 63 resisters a device to be communicated with projector 100 and a user who operates the device. Specifically, when network I/F 107 receives a log-in request from each of PC 300, 300A-300F, the log-in request is accepted. The log-in request includes user identification information for identifying a user and a type indicating whether the user is a presenter or a participant. User registration portion 63 generates a registration record in which device identification information for identifying a device that has transmitted the log-in request is associated with user identification information and the type included in the log-in request, and stores the generated registration record in flash memory 103. Here, the presenter operates PC 300 and six participants operate their respective PC 300A-300F, and therefore stored are a registration record in which the device identification information of PC 300, the user identification information of the user who operates PC 300, the type of presenter are associated with each other as well as six registration records in which the respective device identification information of PC 300A-300F, the user identification information of the respective users who operate PC 300A-300F, and the type of participant are associated with each other.

When network I/F 107 receives data from PC 300, data acquisition portion 51 acquires the data. A description here will be made to a case where image data is received from PC 300. PC 300 is operated by a presenter and has presentation data stored therein. The presenter operates PC 300 to designate one of a plurality of pages included in the presentation data, so that the image data of that page is transmitted to projector 100. The format of image data is not specifically limited as long as it can be received by projector 100. Here, image data is in the bit map format. Data acquisition portion 51 outputs the acquired image data to presentation page transmission portion 53 and first display control portion 55.

Presentation page transmission portion 53 transmits the image data input from data acquisition portion 51 to each of PC 300A-300F operated by the participants. Accordingly, the image of the image data, namely, the image of one page selected by the presenter from a plurality of pages included in the presentation data, is displayed on operation portion 306 of each of PC 300A-300F.

First, display control portion 55 outputs the image data input from data acquisition portion 51 to projection portion 109 to cause projection portion 109 to project the image of the image data.

When network I/F portion 107 receives a message from any of PC 300A-300F operated by the participants, message reception portion 59 receives the message. Message reception portion 59 outputs the received message to count portion 61. The messages output by PC 300A-300F each include a position in the image of the image data output by presentation page transmission portion 53 and a message type, as detailed later.

When receiving a message from message reception portion 59, count portion 61 counts all the messages received so far and outputs the count result to change portion 57. Count portion 61 divides an image into a plurality of regions and counts the number of messages received from message reception portion 59 for each of a plurality of regions and for each message type. Therefore, the count result is the number of messages for each of a plurality of regions and for each message type. Here, the count result is represented in a count table and the number of messages is counted for each of 16 regions obtained by dividing an image into four equal parts both vertically and horizontally.

The messages counted by count portion 61 are those received from message reception portion 59 in a period between transmission of data and transmission of the next data by presentation page transmission portion 53. Therefore, count portion 61 deletes all the messages that have been input so far when presentation page transmission portion 53 transmits image data.

FIG. 5 shows an example of the count table. Referring to FIG. 5, the count table includes, for each of 16 regions, the number of messages having the message type “agree,” the number of messages having the message type “objection,” and the number of messages having the message type “unknown.” Here, an image is divided in the vertical direction into four regions denoted by A, B, C, D in order from the top, and an image is divided in the horizontal direction into four regions denoted by 1, 2, 3, 4, in order from the left. For example, a region specified by a row “A” and by a column “1” is a region in the leftmost of the top of the four equal parts obtained by dividing an image in the vertical direction. In the count table shown in FIG. 5, the number of messages in the region specified by the row “A” and the column “3” is “2” to indicate that two participants have an objection to the region on the top, third from the left of the image. Furthermore, the number of message in the region specified by the row “A” and the column “4” is “1” to indicate that one participant has an objection to the region on the top, fourth from the left of the image.

Change portion 57 generates a composite image by changing an image output by first display control portion 55 to projection portion 109 based on the count result input from count portion 61. Change portion 57 outputs the composite image to first display control portion 55 to allow projection portion 109 to project the composite image.

Change portion 57 includes a combination portion 71 and a display manner changing portion 73. Combination portion 71 generates a composite image by combining an instruction image indicating presence of a message with an image output by first display control portion 55 to projection portion 109, based on a count result input from count portion 61. The instruction image is preferably arranged in a blank region where nothing is drawn in the image.

Display manner changing portion 73 changes the shape and display manner of the instruction image based on the type and number of messages. Here, the display manners to be changed are the shape and the number of instruction images. Display manner changing portion 73 changes the instruction image into a predetermined shape corresponding to the message type based on the message type and changes the number of instruction images based on the number of messages. Specifically, display manner change portion 73 predetermines the shape of instruction image depending on the message type. Here, the message type includes three kinds, namely, “agree,” “objection,” and “unknown.” The shape of instruction image for the message type “agree” is a symbol “@,” the shape of instruction image for the message type “objection” is a symbol “!,” and the shape of instruction image for the message type “unknown” is a symbol “?.” In addition, display manner change portion 73 increases the number of instruction images in proportion to the number of messages.

The composite image is projected on a screen by projection portion 109 and displayed on the screen, so that the presenter can know the presence of messages of the participants from the instruction image and can know the message type from the shape of the instruction image and the number of messages from the number of instruction images. In this manner, the presenter can recognize the intent of the participants from the image displayed on the screen since the displayed image reflects the intent of the participants.

A change in display manner may not limited to a change in shape and number, and the hue, brightness and/or saturation may be changed or the size of instruction image may be changed. Alternatively, in another manner of changing the display manner, the instruction image may be caused to flash and the flashing intervals may be changed. In a case where the shape is not changed, the instruction image is not limited by the size, thereby facilitating arrangement of the instruction image.

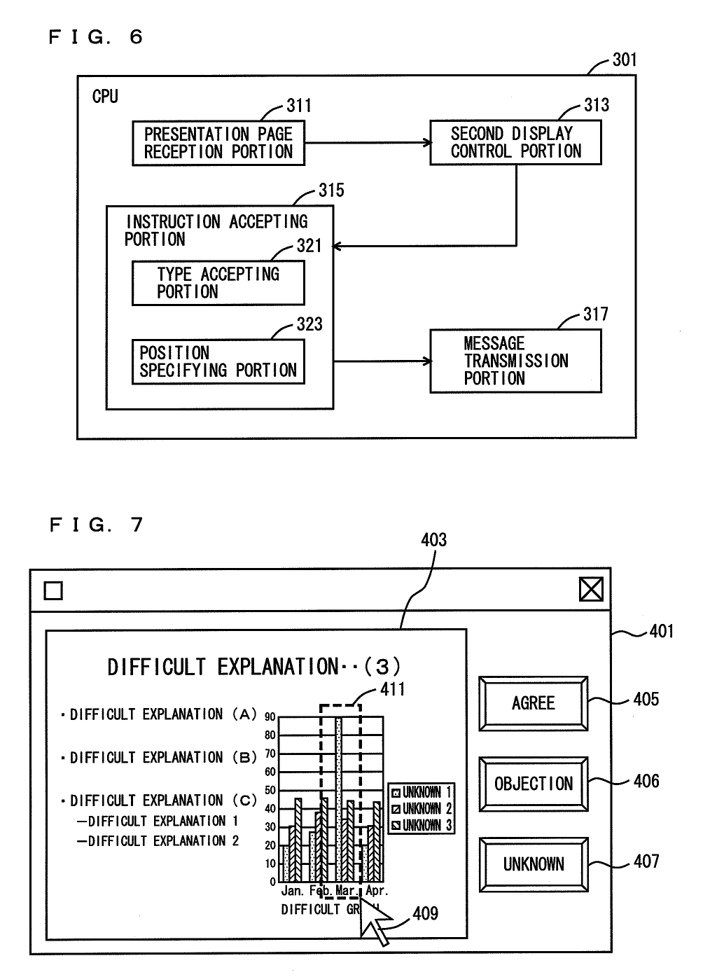

FIG. 6 is a functional block diagram showing an example of functions of CPU included in PC operated by participants. Those functions are realized by CPU 301 executing a program stored in ROM 302 or CD-ROM 309A. The functions realized in PC 300A-300F operated by participants are the same, and therefore PC 300A operated by a participant will be described. Referring to FIG. 6, CPU 301 of PC 300A operated by a participant includes, as the above-noted functions realized by execution of a program, a presentation page reception portion 311 receiving a presentation page, a second display control portion 313 displaying an image of a presentation page on display portion 306, an instruction accepting portion 315 accepting an instruction by the user, and a message transmission portion 317 sending a message in accordance with the accepted instruction.

When network I/F 304 receives image data from projector 100, presentation page reception portion 311 acquires the received image data. Then, the received image data is output to second display control portion 313.

Second display control portion 313 outputs a presentation screen including an image of the image data input from presentation page reception portion 311 to display portion 306 to allow display portion 306 to display the presentation screen. Second display control portion 313 also outputs the presentation screen output to display portion 306, to instruction accepting portion 315.

Instruction accepting portion 315 accepts an instruction input to operation portion 307 by the user. The instruction input to operation portion 307 by the user includes a position in the image of image data input from presentation page reception portion 311 and a message type. Instruction accepting portion 315 includes a type accepting portion 321 and a position specifying portion 323. Type accepting portion 321 selects any of a plurality of predetermined message types, here, “agree,” “objection,” and “unknown.” Specifically, when any one of three buttons included in the presentation screen is designated, a predetermined message type corresponding to the designated button is accepted. Position specifying portion 323 specifies a region specified by the user in the image included in the presentation screen. Instruction accepting portion 315 outputs the message type and the position in the image to message transmission portion 317. Message transmission portion 317 transmits a message including the message type and the position in the image to projector 100 through network I/F 304.

FIG. 7 shows an exemplary presentation screen. Referring to FIG. 7, a presentation screen 401 includes a region 403 to display an image of image data, a button 405 with characters “agree,” a button 406 with characters “objection,” and a button 407 with characters “unknown.” Button 405 is related to the message type “agree,” button 406 is related to the message type “objection,” and button 407 is related to the message type “unknown.”

A region 411 is a region in region 403 that is pointed to by the user using a mouse pointer 409. When the user points to any one of buttons 405, 406, 407 with region 411 being designated, a predetermined message type corresponding to the designated one and the position of region 411 in the image displayed in region 403 are input.

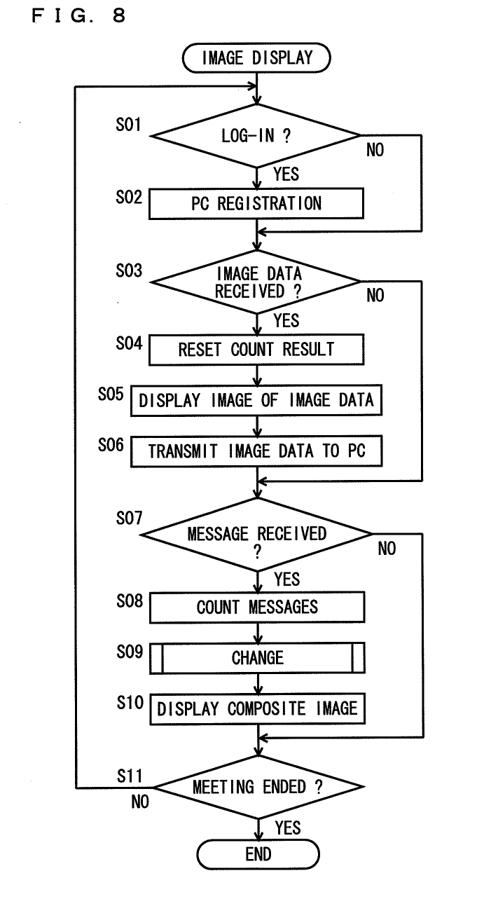

FIG. 8 is a flowchart illustrating an exemplary flow of an image display process. The image display process is a process executed by CPU 101 when CPU 101 of projector 100 executes an image display program.

Referring to FIG. 8, CPU 101 determines whether or not a log-in is accepted (step S01). It is determined whether or not network I/F 107 receives a log-in request from any of PC 300, 300A-300F. If a log-in request is received, the process proceeds to step S02. If not, step S02 is skipped and the process proceeds to step S03. In step S02, PC that has transmitted the log-in request is registered, and the process then proceeds to step S03. Specifically, a registration record is generated in which device identification information for identifying the one of PC 300, 300A-300F that has transmitted the log-in request is associated with the user identification information and the type included in the log-in request. The registration record is then stored in flash memory 103. The type indicates whether the user who operates PC that has transmitted the log-in request is a presenter or a participant.

In step S03, it is determined whether image data of a new page is received from PC 300 operated by the presenter. If image data of a new page is received, the process proceeds to step S04. If not, the process proceeds to step S07. In step S04, the count result is reset. Specifically, all the messages that have been received in step S07 as described later before image data of a new page is received in step S03 are deleted. The instruction image is displayed for each image data in order to reflect the opinions of participants on a basis of image data (page). In a manner in which image data is successively transmitted frame-by-frame from PC 300 to projector 100 and then displayed, it may be determined that image data of a new page is received, by detecting that the content of an image is changed more than a certain degree.

In the next step S05, an image of image data received in step S03 is displayed. Specifically, an image of image data is output to projection portion 110 for projection.

In step S06, the image data received in step S03 is transmitted to all the PC registered as participants in step S02. Here, the image data is transmitted to each of PC 300A-300F. Accordingly, the same image as the image projected by projection portion 109 and displayed appears on each of PC 300A-300F.

In step S07, it is determined whether a message is received or not. It is determined whether network I/F 107 receives a message from any of PC 300A-300F operated by the participants. If a message is received, the process proceeds to step S08. If not, the process proceeds to step S11.

In step S08, the messages received so far are counted. Accordingly, the count table shown in FIG. 5 is generated. Then, in the next step S09, a change process is executed. The change process, which will be detailed later, is a process of combining an instruction image with an image of image data in accordance with the count table.

In the next step S10, a composite image generated by changing image data through a change process is displayed. Specifically, a composite image is output to projection portion 109 to allow projection portion 109 to project the composite image. The composite image includes an instruction image and therefore allows the presenter or the participants to know which opinion the participants have on the displayed image.

In the next step S11, it is determined whether the meeting is ended or not. It is determined whether a signal for ending the meeting is received or not from PC 300 operated by the presenter. If a signal for ending the meeting is received, the process ends. If not, the process returns to step S01.

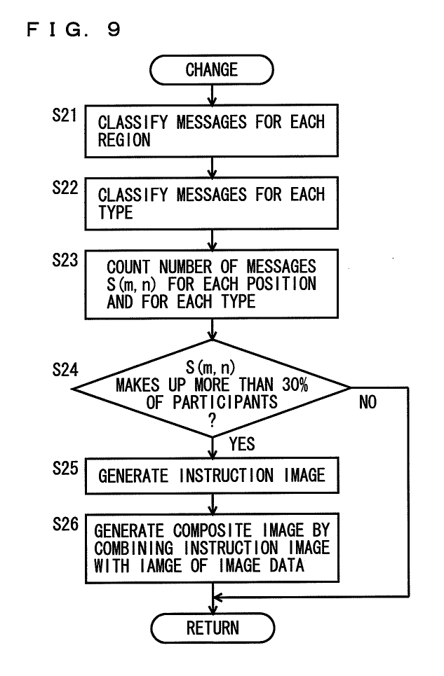

FIG. 9 is a flowchart illustrating an exemplary flow of a change process. The change process is a process executed in step S09 in FIG. 8. Referring to FIG. 9, in step S21, messages are classified for each region. Here, for each of 16 regions obtained by dividing an image into four equal parts both vertically and horizontally, messages are classified region-by-region based on the positions including them. In the next step S22, messages are classified by message type. The messages classified for each region in step S21 are classified by message type in each region.

In the next step S23, the number of messages is counted for each position and for each type. In other words, of the messages included in the same region, the number of messages of the same message type is counted. Accordingly, the count table shown in FIG. 5 is generated. Then, in the next step S24, it is determined whether or not the number of messages makes up more than 30% of the participants. It is determined whether or not there exists a cell of region and message type in which messages that makes up more than 30% of the participants are allotted, in the count table shown in FIG. 5. If there exists a cell in which messages making up more than 30% of the participants are allotted, the process proceeds to step S25. If not, the process returns to the image display process. In step S25, an instruction image is generated. The shape of the instruction image is determined by the message type corresponding to the cell in which messages making up more than 30% of the participants are allotted in step S24, and the number of instruction images is determined by the number of messages. In the next step S26, a composite image is generated by combining the instruction image generated in step S25 with the image of image data, and the process then returns to the image display process.

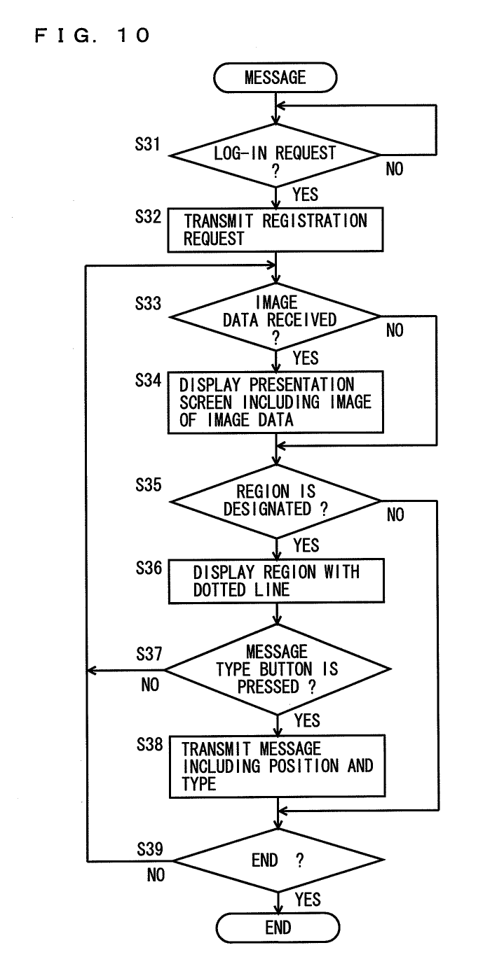

FIG. 10 is a flowchart illustrating an exemplary flow of a message process. The message process is a process executed in each of PC 300A-300F operated by the participants. The message process is executed by CPU 301 when CPU 301 of each of PC 300A-300F operated by the participants executes an image display process. Here, PC 300A executes a message process by way of example.

Referring to FIG. 10, CPU 101 of PC 300A determines whether a long-in request is accepted or not (step S31). When it is detected that the user inputs the user identification information and the type, here, participant, in operation portion 307, a log-in request is accepted. The process is on standby until a log-in request is accepted (NO in step S31). When a log-in request is accepted (YES in step S31), the process proceeds to step S32. In step S32, a registration request is transmitted to projector 100. Specifically, a registration request including the user identification information and the type input in step S31 is transmitted to projector 100.

In the next step S33, it is determined whether or not image data is received from projector 100. If image data is received, the process proceeds to step S34. If not, step S34 is skipped and the process proceeds to step S35. In step S34, a presentation screen including an image of the received image data is displayed on display portion 306, and the process proceeds to step S35. Accordingly, the presentation screen shown in FIG. 7 is displayed on display portion 306.

In step S35, it is determined whether specification of a region is accepted or not. If specification of a region is accepted, the process proceeds to step S36. If not, the process proceeds to step S39. It is determined whether an operation of the user operating operation portion 307 to specify part of the image displayed in step S34 is accepted or not. If an operation of specifying part of the image is accepted, the specification of a region is accepted. In step S36, the specified region is displayed with a dotted line. This allows the user to confirm the specified region.

In the next step S37, it is determined whether the message type button is pressed or not. It is determined whether any of buttons 405-407 included in the presentation screen is pressed or not. If any of buttons 405-407 is pressed, the process proceeds to step S38. If not, the process returns to step S33. In step S38, a message including the position in the image of the region specified in step S35 and the message type corresponding to the button that is detected to be pressed in step S37 is transmitted to projector 100.

In the next step S39, it is determined whether the meeting is ended or not. If an end signal is received from projector 100, it is determined that the meeting is ended. If the meeting is ended, the process ends. If not, the process returns to step S33.

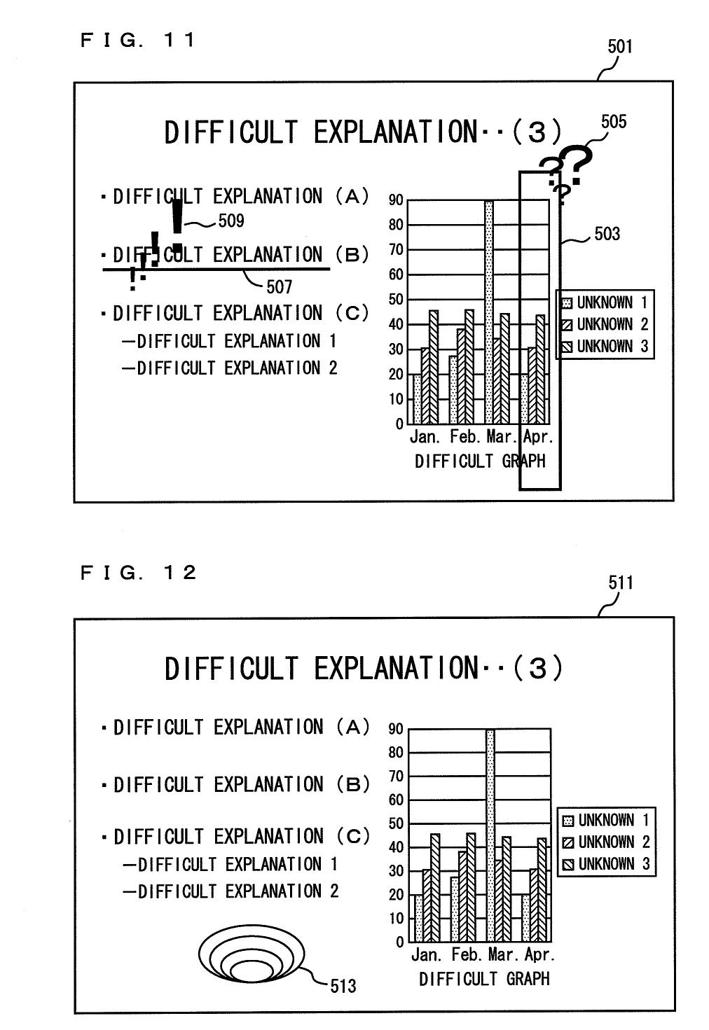

FIG. 11 shows an exemplary composite image. Referring to FIG. 11, a composite image 501 includes a region 503 and a region 507 in which an instruction image 505 and an instruction image 509 are respectively displayed. Instruction image 505 includes symbols “?” indicating that many participants do not understand the meaning about the portion of region 503. Furthermore, instruction image 509 includes symbols “!” indicating that many participants have an objection to the portion of region 507.

<Modified Composite Image>

In the embodiment as described above, an image is divided into a plurality of regions and an instruction image is displayed for each region. However, an image may not be divided and an instruction image may be displayed for the entire image. FIG. 12 shows an exemplary composite image in a modified embodiment. Referring to FIG. 12, a composite image 511 in the modified embodiment includes an instruction image 513. Instruction image 513 is oval and indicates that the message type is “agree.” Although instruction image 513 is shown in the figure as a graphic of overlapping four ovals having different sizes, only for the sake of illustration, it is actually formed of the largest oval. The size of instruction image 513 represents the number of participants who have sent messages with the message type “agree.” Here, instruction image 513 is shown as a graphic of overlapping four ovals, which suggests that 40% of the participants have sent messages with the message type “agree.”

Although here the size of the instruction image represents the proportion of participants who have sent messages, brightness may be increased as the proportion of participants who have sent the same message type increases. Furthermore, although here the shape of instruction image 513 varies according to the message type, the hue of the instruction image may be varied according to the message type. For example, green may be related to the message type “agree,” red may be related to the message type “objection,” and blue may be related to the message type “unknown.”

### Second Embodiment

In the first embodiment above, an instruction image is combined with an image of image data. In the second embodiment, projector 100 as an image display apparatus changes a display manner of an image of image data in place of combining an instruction image based on the received message. Specifically, the background color of the image of the image data is changed base on the message type and the number of messages. In order to represent the message type and the number of messages with the background color of the image, the message type is represented by a hue, and the number of message is represented by brightness.

For example, green is associated with the message type “agree,” red is associated with the message type “objection,” and blue is associated with the message type “unknown.” The brightness is set higher as the number of messages is greater.

As described above, projector 100 as an image display apparatus in the present embodiment includes display control portion 53 outputting an image to be displayed on a screen to projection portion 109, message reception portion 59 receiving a message from PC 300A-300F connected to be able to communicate, count portion 61 counting one or more messages, and a change portion 57 changing an image to be displayed based on the counted number of messages. The image displayed on a screen has been changed based on the counted number of messages, so that the presenter of the meeting can know the number of messages of participants from the image displayed on the screen.

Furthermore, change portion 57 combines an image with an instruction image indicating that there is a message, so that the presence of a message can be known from the instruction image included in the displayed composite image. Moreover, the display manner of the instruction image is changed based on the counted number of messages, so that the number of messages can be known from the display manner of the instruction image.

In addition, since a composite image is generated by combining an image with an instruction images that varies depending on the message type, the type of message can be known from the instruction image.

Furthermore, messages are counted for each position in an image and a composite image is generated by combining the image with an instruction image for each position in the image, so that the position in the image that is targeted by the messages can be known.

In addition, messages are counted and a composite image is displayed before images of a plurality of pages included in presentation data are switched from one to another, so that the intent of participants can be known for each page image.

In the foregoing embodiments, a projector has been described as an example of the image display apparatus. However, projector 100 may be replaced with a computer connected to a display device such as a liquid crystal display or a projector. In such a case, CPU of the computer has the functions shown in FIG. 4, and first display control portion 55 controls the display device and allows the display device to display images.

It is needless to say that the present invention can be understood as an image display method for executing the processes shown in FIG. 8, FIG. 9, and FIG. 10 and an image display program for causing a computer to execute the image display method.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An image display apparatus comprising:
a display control portion to output an image for display;
a reception portion to receive a message from one or more computers connected to be able to communicate;
a count portion to count one or more messages received by said reception portion; and
a change portion to change said image for display based on the number of said counted messages, if said one or more messages are received by said reception portion.

2. The image display apparatus according to claim 1, wherein
said change portion includes a combination portion to generate a composite image by combining an instruction image indicating presence of said message with an image output by said display control portion, and
said display control portion outputs said composite image.

3. The image display apparatus according to claim 2, wherein said change portion further includes a display manner change portion to change a display manner of said instruction image, based on the number of said counted messages.

4. The image display apparatus according to claim 2, wherein
said count portion counts one or more messages received by said reception portion for each message type, and
said combination portion combines an instruction image that varies depending on said message type, with said image.

5. The image display apparatus according to claim 2, wherein
said reception portion receives a position in said image for display, together with said message,
said count portion counts one or more messages received by said reception portion for each position in said image, and
said combination portion combines said instruction image with said image for display for each position in said image.

6. The image display apparatus according to claim 1, wherein said count portion counts messages received by said reception portion before said display control portion outputs another image.

7. The image display apparatus according to claim 1, further comprising a display portion controlled by said display control portion to display an image.

8. The image display apparatus according to claim 1, wherein said display control portion outputs said image for display to an externally connected display device to allow said display device to display said image.

9. An image display system comprising an image display apparatus and one or more computers,
said image display apparatus including
a display control portion to output an image for display,
a message reception portion to receive a message from one or more computers connected to be able to communicate,
a count portion to count one or more messages received by said reception portion,
a change portion to change said image for display based on the number of said counted messages, if said one or more messages are received by said reception portion, and
a transmission portion to transmit said image for display to each of said one or more computers,
each of said one or more computers including
an image reception portion to receive said image for display,
an instruction accepting portion to accept an instruction by a user, and
a message transmission portion to transmit a message based on said accepted instruction.

10. The image display system according to claim 9, wherein
said accepting portion included in each of said one or more computers further includes
a position specifying portion to specify a position in said displayed image, and
a type accepting portion to accept one of predetermined different types of messages,
said message transmission portion transmits a message including said accepted position in said image and said accepted type,
said count portion included in said image display apparatus counts one or more messages received by said reception portion, for each said message type and for each position in said image, and
said combination portion combines an instruction image that varies depending on said message type, with said image, for each position in said image.

11. An image display method comprising the steps of:
outputting an image for display;
receiving a message from one or more computers connected to be able to communicate;
counting one or more messages received by said reception portion; and
changing said image for display based on the number of said counted messages, if said one or more messages are received by said reception portion.

12. An image display program embodied on a computer readable medium for allowing a computer to execute the steps of:
outputting an image for display;
receiving a message from one or more computers connected to be able to communicate;
counting one or more messages received by said reception portion; and
changing said image for display based on the number of said counted messages, if said one or more messages are received by said reception portion.

13. The image display program according to claim 12, wherein
said changing step includes the step of generating a composite image by combining an instruction image indicating presence of said message with the image output in said outputting step, and
said outputting step includes the step of outputting said composite image.

14. The image display program according to claim 13, wherein said changing step further includes the step of changing a display manner of said instruction image based on the number of said counted messages.

15. The image display program according to claim 13, wherein
said counting step includes the step of counting one or more messages received in said receiving step, for each message type, and
said step of generating a composite image includes the step of combining an instruction image that varies depending on said message type, with said image.

16. The image display program according to claim 13, wherein
said receiving step includes the step of receiving a position in said image for display, together with said message,
said counting step includes the step of counting one or more messages received in said receiving step, for each position in said image, and
said step of generating a composite image includes the step of combining said instruction image with said image for display for each position in said image.

17. The image display program according to claim 12, wherein said counting step counts messages received in said receiving step before another image is output in said outputting step.

18. The image display program according to claim 12, wherein said outputting step includes the step of outputting said image for display to an externally connected display device to allow said display device to display said image.
